(19) United States
(12) Patent Application Publication
(10) Pub. No.: US 2023/0276991 A1
(43) Pub. Date: Sep. 7, 2023

(54) Kitchen Appliance System and Method of Operating a Kitchen Appliance System

(71) Applicant: Vorwerk & Co. Interholding GmbH, Wuppertal (DE)

(72) Inventors: Nils Beckmann, Remscheid (DE); Kevin Schmitz, Haan-Gruiten (DE); Torsten Lang, Solingen (DE); Miron Sernecki, Hagen (DE); Felix Haunschild, Essen (DE)

(21) Appl. No.: 18/117,527

(22) Filed: Mar. 6, 2023

(30) Foreign Application Priority Data
Mar. 7, 2022 (EP) 22160526.4

(51) Int. Cl. A47J 43/046; A47J 43/07; A47J 43/08; A47J 36/32; G06F 3/0484

(52) U.S. Cl. CPC A47J 43/046; A47J 43/075; A47J 43/085; A47J 36/321; G06F 3/0484; A47J 2201/00

(57) ABSTRACT

The invention relates to a kitchen appliance system with a base unit including a housing, a control device and a communication interface and with at least one accessory including an identifier. In order to improve user-friendliness, provision is made for a detection device which is configured to detect an identifier of at least one accessory. The control device is configured to control an identifier which is detected by the detection device with at least one identifier from a database, to provide at least one operation mode associated with an identifier from the database matching the detected identifier via the communication interface as a quick start mode. The invention further relates to a method of operating a kitchen appliance system and a corresponding computer program.

### CROSS REFERENCE TO RELATED APPLICATION

This application claims priority to European Patent Application No. 22160526.4, filed Mar. 7, 2022, the disclosure of which is hereby incorporated by reference in its entirety.

### BACKGROUND OF THE INVENTION

### Field of the Invention

The invention relates to a kitchen appliance system with a base unit comprising a housing, a control device and a communication interface, and with at least one accessory comprising an identifier. The invention also relates to a method for operating a kitchen appliance system.

### Description of Related Art

Kitchen appliances of the type mentioned above are already known, in particular for processing raw or semi-finished food products. These kitchen appliances have a base unit with which separate components interact in order to process a food product depending on the dish, drink or the like obtained. Such components are typically sold by food processor suppliers as accessories, for example, a cooking vessel, a cooking vessel, a lid, a cutting or stirring unit or the like. Generally, the accessory and the base unit each have interfaces that are compatible with each other and enable the two components to interact. In particular, interfaces brought into interaction with each other can be used to drive a movable element of the accessory by means of an electric motor arranged in the base unit.

Often, kitchen appliance systems are sold with a selection of preparation instructions such as cooking recipes, for the execution of which the accessories sold with them are used. These preparation instructions can be made available to the user in paper form as a book or also in digital form, for example on a data carrier such as a USB stick or stored in a database that is stored on a storage medium of the control device of the kitchen appliance system. Over time and with the purchase of additional accessories, the number of preparation instructions increases and it becomes increasingly difficult for the user to keep track of them or to find a specific preparation instruction.

### SUMMARY OF THE INVENTION

Against this background, the present invention is based on the problem of improving known kitchen appliance systems and, in particular, increasing the prospects of success and user-friendliness when using a kitchen appliance system.

This problem is solved with a kitchen appliance system of the type mentioned at the beginning in that a detection device configured to detect an identifier of at least one accessory is provided, and in that the control device is configured to compare an identifier detected by the detection device with at least one identifier from a database, and to make available at least one operation mode, which is linked to an identifier from the database that matches the detected identifier, as a quick start mode via the communication interface.

For example, the kitchen appliance system provides intelligent pre-sorting of relevant preparation instructions and reduces the number of user inputs until preparation instructions applicable to the accessory are displayed. In addition, the ‘quick start mode’ format allows further minimisation of user input until the actual execution of the preparation procedure corresponding to the quick start mode is started.

A base unit in the sense of the present invention is preferably designed as a base for the use of accessories by having an interface for interaction with at least one accessory. The base unit has a housing wherein an electric motor for driving accessories is arranged. The electric motor then interacts with an accessory assembled with the base unit via the interface of the base unit.

Accessory is understood to be any part designed for interaction with the base unit. The accessory may be directly or indirectly assembled into the base unit, wherein for direct assembly the accessory has an interface compatible with the interface of the base unit, and wherein for direct assembly the accessory is attached to another accessory which is in turn directly assembled with the base unit. The term “assembly” includes, but is not limited to, the actions from the list: Connecting, coupling, mounting, attaching, fitting and the like. In particular, an accessory is designed to extend the function of the base unit, for example as a cutting, stirring, cooking, weighing, cooking, steaming or covering unit. The function for which the accessory is intended preferably designates the type of accessory.

The term identifier includes any information about at least one property of the accessory. Preferably, the identifier is sufficient to identify an accessory or to be able to assign it in the context of a database. An identifier in the sense of the invention may be selected from the non-exhaustive list: Accessory type, such as cutting, stirring, cooking, weighing, cooking, steaming or covering unit; Origin information, such as manufacturer identity, date of manufacture, place of manufacture; Authentication information; Identification number, such as a serial number or a Universally Unique Identifier (UUID). Preferably, the identifier has been assigned by the accessory manufacturer prior to distribution.

The information feature is preferably stored on a data carrier which is integrated in the base body of the accessory or permanently attached to the base body of the accessory. Several data carriers can be provided, each of which carries an identifier and which are arranged at different positions on the accessory. Thus, depending on the position of use or the direction wherein the accessory is assembled with the base unit, an identifier corresponding to the position of use can be detected. Alternatively or additionally, a data carrier can have several identifiers, each of which is detected depending on the assembly position of the accessory on the base unit. In particular, a data carrier can be switchable, for example with the aid of a magnet, and provide a corresponding identifier for detection depending on the switching position or switching state. In this way, a suitable quick-start mode can be automatically called up for an accessory that can assume several operating positions on the basic device, depending on its current operating position.

The detection device or detector is configured to detect the identifier of the accessory. If, for example, the identifier is attached to the accessory in the form of a QR code, the detection device is preferably designed as an optical reader. The detection device can also be a reader for a data memory connected to an RFID antenna, a part of a short-range radio system (e.g. Bluetooth, ultra-wide band (UWB) or WLAN) or a part of a bus system. The detection device can be arranged at the basic body or be designed as a device separate from the basic body and the accessory, for example as a smartphone with a detection element such as an integrated camera, which is directly or indirectly connected via the communication interface to the control device of the basic device for a data exchange.

Furthermore, the detection device may be connectable via a communication link to a detection element arranged at a first accessory. The detection element is preferably configured to detect an identifier of a further accessory. In this way, the further accessory can first be recognised and then be used for intended use on the base unit or on the first accessory. This is particularly advantageous for accessories whose identifier is difficult to detect in the intended use position, in particular due to insufficient signal transmission through the base of a first accessory designed as a cooking unit.

Furthermore, a control device is arranged in the housing or on the housing of the base unit. The control device or controller preferably comprises a processor with a storage medium. In particular, a computer program with instructions may be stored on the storage medium, the execution of which by the processor causes the kitchen appliance to perform an operating procedure.

A database with identifiers and cooking information or preset operating modes can be stored on the storage medium. Preferably, such a database is stored on the storage medium of the control device that access to an external information source or to an external database can be dispensed with during operation. The kitchen appliance system, in particular the control device, can be configured in such a way that the control device accesses an external database if the information stored in the database on the storage medium of the database is not sufficient. For example, when using an accessory for the first time, the control device may access an external database to download cooking information for that accessory to its storage medium. In addition, the control device is preferably connectable to an external server, for example a server of the manufacturer of the kitchen appliance system, for access via the Internet.

Identifiers are stored in the database, with which at least one operation mode is linked in each case. An operation mode is understood to be a unit of operating parameters and preparation instructions for carrying out a preparation process on the kitchen appliance system. An operation mode can comprise a selection of predetermined set values for operating parameters and/or preparation instructions, which are then presented to the user for selection when the operation mode has been selected from a list of operation modes.

For example, an operation mode may include at least one setpoint for an operating parameter for a component of the kitchen appliance system and/or at least one preparation instruction for a step to be performed by the user. These include, for example, an ingredient type, a setpoint for an ingredient quantity, a setpoint for an ingredient weight, a setpoint for an ingredient volume, a setpoint for a speed for the electric motor, a setpoint for a direction of rotation for the electric motor, a setpoint for a torque of the electric motor, a setpoint for a temperature, a setpoint for a humidity level, a setpoint for a duration, information from a cooking recipe, an introduction for the first use of an accessory on the base unit. In particular, an operation mode is configured to the characteristics of the kitchen appliance and its components so that the application of the cooking information is limited as far as possible to the use of the kitchen appliance and its original accessories.

Preferably, the control device is configured to link a operation mode corresponding to a user input detected by the communication interface with an identifier and to store this link in the database. The link can be made by the user, i.e. after distribution of the kitchen appliance system, and/or by the kitchen appliance system manufacturer before distribution. Furthermore, a specific identification number, such as a serial number or a Universally Unique Identifier (UUID), of a specific accessory can be linked to a quick start mode, so that not all accessories of a type are linked to this quick start mode, but only the one accessory. This allows individualisation of the accessories and the menu guidance or digital accompaniment when cooking with the kitchen appliance system.

The control device is configured to make an operation mode available as a quick start mode via the communication interface. The term “quick start mode” is understood to mean a modification of an operating mode that allows a simplified and quick start of a corresponding preparation process. Preferably, setpoints for operating parameters are essentially preset in a quick start mode, so that the number of user requests is reduced compared to a standard operation mode wherein setpoints are first entered. In particular, in a quick start mode, the number of adjustable parameters may be less than in the operation mode from which the quick start mode is modified. For example, a “boiling water” operation mode may offer several setpoints for a temperature to choose from, such as 70° C., 80° C., 90° C. and 100° C., suitable for preparing water for tea, or simply for bringing water to the boil. A corresponding quick start could then have a single setpoint of “70° C.” so that user input can be dispensed with and the preparation process can be started automatically.

Additionally or alternatively, a quick start mode may be a operation mode that has gone through a formatting step for ease of access. Thus, prioritising a particular operation mode over other operation modes may correspond to a conversion to a quick-start mode.

Further preferably, a quick start mode corresponds to a parameter preset for a preparation process using at least one specific accessory. An example of such a quick start mode is a preset at a set temperature of 100° C. and a duration of 2 minutes for an accessory designed as a kettle vessel. Another example is a preset for a sous-vide type preparation of a piece of meat when the accessory is a knife cover.

Furthermore, a quick start mode can be defined in such a way that it is called up or made available when a specific accessory combination is detected. For example, several lids can be combined with a cooking unit, whereby a quick start mode is called up and made available depending on the detection of a particular lid.

A communication interface can be a user interface in the form of an acoustic, haptic or visual display, but also an interface for forwarding information to a user terminal such as a smartphone or a digital home management system. Thus, the communication interface provides information directly, i.e. for example itself as a display, or indirectly via an additional user interface.

Preferably, the control device provides an operation mode applicable to the detected identifier as a quick start mode by exclusive display. For example, the communication interface can display only one quick start mode, in particular without displaying other operation modes. In this way, the kitchen appliance system provides the user with a clear display.

According to a first embodiment of the kitchen appliance system, the quick start mode comprises at least one item from the list: a preset configured to the accessory, a preparation instruction corresponding to a preparation operation that can be performed with the accessory, a setpoint for a preparation parameter, a user request about a parameter setting, a user request about a confirmation for starting a preparation operation.

Thus, all operating parameters for the kitchen appliance system can be preset and also predetermined setpoints can be output in the form of clear user prompts to assist the user in carrying out a preparation process corresponding to the quick start mode. In addition, by displaying user prompts from quick start mode, settings can still be made or, for example, the start of a preparation process can be delayed and/or confirmed.

According to a further embodiment of the kitchen appliance system, the control device is configured to switch the communication interface from an idle mode to an active mode as a consequence of a detection of an identifier and to provide a quick start mode corresponding to the detected identifier via the communication interface when switching to the active mode.

Thus, immediately after the detection of an accessory or the recognition of the assembly of an accessory, the communication interface can be automatically activated and a quick start mode suitable for the accessory can be displayed. In this way, a time-consuming input concerning, for example, the type of accessory and a selection of an operation mode from a list of operation modes can be dispensed with.

The sleep mode is preferably a state wherein the activity of the communication interface is shut down to, among other things, save power. The sleep mode may be a hibernation mode, where the power supply to the communication interface is cut off, or a stand-by mode, where the power supply is maintained. For example, if the communication interface is designed as a screen, a dark image or a screen saver may be displayed in sleep mode, or the pixels may be turned off.

Preferably, the quick start mode is made available together with the start-up of the communication interface in an active mode. When the communication interface is designed as a screen, the first displayed image can then have at least one piece of information from the quick start mode. If the communication interface is designed to forward information to a user terminal such as a smartphone, for example, then the communication interface preferably forwards data packets corresponding to the content of the quick start mode to the smartphone during start-up.

Alternatively or additionally, a sleep mode may be a state of the kitchen appliance system wherein the control device provides a selection menu via the communication interface, but functional elements such as the electric motor are inactive. Thus, a change from idle mode to active mode can occur when selecting a quick start mode.

The position of an accessory can be detected in relation to the base unit. If at least two accessories are provided, then the position of a second accessory, for example a cutting unit, can be detected in relation to the position of a first accessory, for example a mixing bowl. Overall, the position detector may be configured to detect the position of one or more accessories, and the control device may be configured to automatically detect the assembly or removal of one or more accessories together. For example, it may be automatically detected whether an accessory is correctly assembled with or in a cooking vessel, and also whether the cooking vessel is in turn correctly assembled with the base appliance.

According to a further embodiment of the kitchen appliance system, a position detector is provided and is configured to detect an assembly or removal of at least one accessory with respect to the base unit and/or with respect to a further accessory and to forward this to the control device, and the control device is configured to provide a quick-start mode as a function of a detected identifier and of a detected assembly or removal of an accessory, to make a quick-start mode available as a function of a detected identifier and of a detected assembly of an accessory, and/or to end the making available of a quick-start mode as a function of a detected identifier and of a detected removal of an accessory.

For example, the kitchen appliance system automatically provides a suitable quick-start mode when an accessory is assembled with the base unit. In addition, the kitchen appliance system is capable of automatically terminating a quick start mode display when the accessory is disconnected from the base unit. For example, a main menu can be displayed.

The control device provides a quick start mode depending on a detected position of an accessory. Thus, for example, an applicable quick start mode can only be made available when an assembly of an accessory is detected. This avoids providing a quick start mode that is applicable to accessories that may well be detected by the detection device in the vicinity of the base unit and their identifier, but are not intended to be used on the base unit. In addition, a provision of the quick start mode can be terminated when a removal of an accessory from the base unit is detected. In this way, cooking information is only provided for accessories that are actually used on the base unit.

Preferably, the control device automatically detects whether the position of an accessory allows it to interact properly with the base unit, or whether it is correctly assemble with the base unit or another accessory. In this way, damage to the accessory and/or the base unit can be avoided.

For example, the position sensing device may be a dedicated device cooperating with an element on the accessory and/or a weighing module. Alternatively or additionally, the detection device for detecting an identifier may function as a position detector by detecting assembly when an identifier enters the detection field of the detection device and detecting removal when an identifier exits the detection field of the detection device. Alternatively or additionally, the position detector can be designed as a separate device from the basic device and the accessory and can be connected to the control device via the communication interface.

The position detector can be arranged in the accessory and/or in the housing of the base unit. Preferably, the accessory has at least one element that is configured to influence the position detector, and the position detector is configured to output a signal or information with position information depending on the influence by the element.

In particular, the interaction of the element of the accessory with the position sensing device may be designed as follows:
Opening or closing an electrical contact between the element on the accessory and the position sensing device by changing the position of the accessory relative to the base unit;
opening or closing of a magnetic contact, for example a reed contact, between an element formed as a magnet on the accessory and the position sensing device by changing the position of the accessory relative to the base unit;
detecting a change in inductance or capacitance caused by interaction of a metal part on the accessory and an active detection element of the position detector; and/or
detecting the intensity of the magnetic field of a magnet arranged at the accessory by an active detection element of the position detector.

According to a further embodiment of the kitchen appliance system, the control device assigns a high priority rank, preferably the highest priority rank, to the quick start mode for making available, and the control device makes information available via the communication interface according to a prioritised arrangement, in particular in an order of descending priority rank.

For example, the quick start mode can be displayed first in a list of operation modes, thus also simplifying access to the quick start mode for the user. In particular, a quick start mode can be assigned a higher priority rank for display than for a operation mode that is not associated with the accessory identifier. Overall, the kitchen system provides an intelligent display and increased user-friendliness.

If several operation modes are to be associated with an identifier matching the detected identifier, then the control device can preferably assign the same priority rank or consecutive priority ranks to each of these operation modes. Thus, the respective quick start modes may be displayed together or grouped together. The priority ranks can also be adjusted and changed by a user, resulting in a preferred order.

According to a further embodiment of the kitchen appliance system, the quick start mode comprises at least one user request and the control device is configured to control functional parts of the kitchen appliance system according to indications from the quick start mode in dependence on a detected user response to the user request.

Such a design enables, for example, a confirmation query as to whether a preparation process should actually be started according to the quick start mode. A confirmation prompt can be advantageous, for example, if several quick start modes are possible for a detected identifier and the user can thus decide which one should be carried out.

Alternatively or additionally, the user request may be a query about an operational parameter or preparation instruction. This may be from the user if these cannot be predicted or preset. Preferably, the control device is configured to adapt at least one operating parameter and/or at least one preparation instruction of the quick start mode to a user response. For example, a setpoint for a cooking time can be configured to a user response regarding an ingredient quantity or a stirring duration can be configured to a user response regarding a stirring speed.

According to a further embodiment of the kitchen appliance system, the quick start mode comprises at least one indication of a preparation process and the control device is configured to start the execution of the preparation process simultaneously with the provision of the quick start mode and to control functional parts of the kitchen appliance system in dependence on the indications.

This means that when an accessory is assembled, a preparation process can start immediately and no user input is required. This embodiment is particularly advantageous if it is clear which operation mode or quick start mode is desired for an accessory. If, for example, a quick start mode has been stored as a favourite for the identifier of the assembled accessory, then user input can be dispensed with and the corresponding preparation process can start without any further action on the part of the user other than assembling the accessory.

Functional parts can be, for example, the electric motor, an accessory, a control for an element of an accessory, such as a control element for a heating element of an accessory, or the communication interface.

According to a further embodiment of the kitchen appliance system, the control device is configured to compare a plurality of detected identifiers with identifiers from a database and to provide, as quick start modes, operation modes each associated with all identifiers from the database matching a detected identifier.

In this way, a quick start mode can be provided that is applicable to several accessories used together or in succession on the base unit. Thus, by assembling all the accessories required for a preparation process on the base unit, the selection of applicable quick start modes can be automatically limited. If several quick start modes are applicable, they are preferably provided together or at least as a group.

According to a further embodiment of the kitchen appliance system, the control device is configured to store a quick-start mode that has already been made available in the past as a favourite, and to make the quick-start mode stored as a favourite available separately when the same identifier is detected again.

This allows the intelligent display to be configured to user preferences and saves user input when the accessory is used later. As a special available position, for example, a particularly accessible position on a screen, an exclusive display, an entry in a list of favourites and/or a particularly accentuated emphasis in an acoustic playback can be provided.

Preferably, a quick start mode stored as a favourite is made available with a higher priority rank than other quick start modes that also apply to the identifier but are not stored as favourites. The quick start mode stored as a favourite can be made available individually.

Quick start modes corresponding to a user input are preferably stored as favourites. Alternatively or additionally, quick start modes are stored as favourites that have already been made available at least once and, if applicable, have also been carried out.

The above-mentioned problem is also solved by a method for operating a kitchen appliance system, in particular a kitchen appliance system according to one of the embodiments described above, wherein at least one identifier of an accessory is detected, wherein the at least one detected identifier is compared with at least one identifier from a database, and wherein at least one operating mode associated with an identifier matching the detected identifier is made available as a quick start mode.

The method and its embodiments explained herein below have the same advantages as the corresponding embodiments of the kitchen appliance system, whereby the embodiments of the kitchen appliance system and the embodiments of the method can be combined with each other and with each other as desired.

According to a first embodiment of the method, following a detection of an identifier, a communication interface is switched from an idle mode to an active mode, and upon switching to the active mode, a quick start mode corresponding to the detected identifier is provided via the communication interface.

According to a further embodiment of the method, an assembly or removal of at least one accessory is detected with respect to the base unit and/or with respect to another accessory, a quick start mode is provided in dependence on a detected identifier and on a detected assembly of an accessory, and/or the provision of a quick start mode is terminated in dependence on a detected identifier and on a detected removal of an accessory.

According to a further embodiment of the method, a high priority rank, preferably the highest priority rank, is assigned to the quick start mode for making available, and quick start modes and/or other operation modes are made available in order of descending priority rank.

According to another embodiment of the method, a user response to a user request from a quick start mode is detected. In a first alternative, functional parts of the kitchen appliance system are controlled according to information from the quick start mode depending on the detected user response. In a further alternative, at the same time as the quick start mode is made available, a preparation process is automatically started in accordance with the quick start mode and functional parts of the kitchen appliance system are controlled in accordance with information from the quick start mode.

According to a further embodiment of the method, the provided quick start mode is stored as a favourite and the quick start mode stored as a favourite is provided separately in case of a later, renewed detection of the same identifier.

Furthermore, the above-mentioned task is solved by a computer program comprising instructions, the execution of which on at least one processor of a control device of a kitchen appliance system according to one of the embodiments described above causes the execution of a method according to an embodiment example explained above.

### BRIEF DESCRIPTION OF THE DRAWINGS

Further features and advantages of the present invention will be apparent from the following description of examples of embodiments, reference being made to the accompanying drawing.

In the drawing show

FIG. 1 a first example of a kitchen appliance system,

FIG. 2 Another example of a kitchen appliance system,

FIGS. 3a and 3b further example of a kitchen appliance system and

FIG. 4 Another example of a kitchen appliance system.

### DESCRIPTION OF THE INVENTION

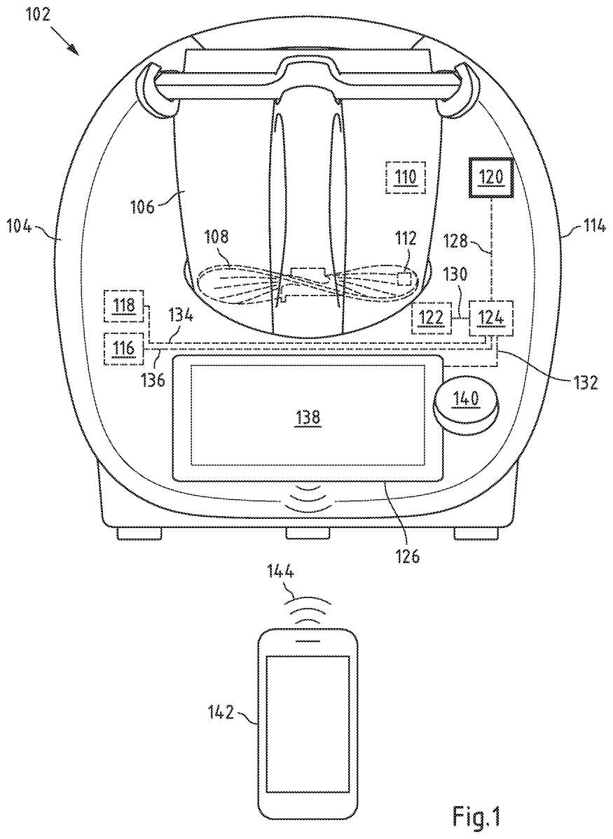

FIG. 1 shows a first embodiment of a kitchen appliance system 102 comprising a base appliance 104, a first accessory 106 configured as a cooking vessel, and a second accessory 108 configured as a blade cover.

The accessories 106, 108 each have a data carrier 110, 112 in the form of an RFID label on which an identifier is stored as machine-readable information. Thus, a first identification number is stored on the data carrier 110 of the first accessory 106 and a further identification number is stored on the data carrier 112 of the second accessory 108. In the illustrated condition, the second accessory 108 is received in the first accessory 106 and the first accessory 106 is in turn assembled with the base unit 104. Thus, the first accessory 106 is assembled directly and the second accessory 108 is assembled indirectly, i.e. via the first accessory 106, on the base unit 104.

The base unit 104 comprises a housing 114, an electric motor 116, a control element 118 for a heating element of the first accessory 106, a detector 120, a storage medium 122 for a database, a controller 124 and a communication interface 126. The controller 124 is connected to the sensing device 120, to the storage medium 122, to the communication interface 126, to the control element 118 and to the electric motor 116 respectively via a communication link 128, 130, 132, 134, 136. The communication interface 126 has a screen 138 and a multifunction button 140 and is connectable to a smartphone 142 via a wireless communication link 144 for data exchange.

The detector 120 is arranged at the base unit 104 and is designed as an RFID reader. Thus, the detector 120 is configured to detect identifiers from the data carriers 110, 112 of the accessories 106, 108. In addition, the storage medium 122 for a database is integrated in the base unit 104. The database comprises a plurality of identifiers and operation modes associated therewith. Each operation mode includes at least one indication of a recommended accessory, preset target values for operating parameters of the kitchen appliance system 102, ingredient types, and the like.

The kitchen appliance system 102, in particular the controller 124 is configured to perform the following method.

As soon as the accessories 106, 108 are assembled with the base unit 104, their data carriers 110, 112 are located in the detection field of the detector 120. The detector 120 then detects the identification numbers of the respective accessories 106, 108 and forwards them to the controller 124. The controller 124 then compares the respective detected identification numbers with the identification numbers stored in the database.

Here, the comparison results in a match in each case. Several operation modes are associated with the identification number from the database that matches the identification number detected for the first accessory 106. These operation modes each correspond to a preparation process wherein ingredients are stirred, cooked, heated, cut or cooked. For the identification number of the second accessory 108, only one operation mode is applicable, namely an operation mode corresponding to a food preparation of the “sous-vide” type. A check by the controller 124 reveals that one of the operation modes applicable to the identification number of the first accessory 106 matches the operation mode applicable to the identification number of the second accessory 108. For example, the sous vide mode of operation is applicable to both the first accessory 106 and the second accessory 108.

The controller 124 assigns a priority rank to each of the operation modes associated with the matching identification numbers from the database, with the priority rank of the sous vide operation mode being the highest. Further, the controller 124 causes the communication interface 126 to display the operation modes in order of priority ranks.

Because the “Sous-Vide” operation mode, i.e. the operation mode applicable to both accessories 106, 108, has the highest priority rank, the communication interface 126 displays it first. This means that this operation mode is easier and quicker to access than the other operation modes and is therefore also available as a quick start mode.

The display by the communication interface 126 is performed on the display screen 138 and, in parallel, on the smartphone 142. The display of the operation mode provided as a quick start mode on the smartphone 142 comprises a first user request corresponding to a confirmation to perform a sous vide preparation operation and a second user request corresponding to a duration for which a food is to be sous vide treated. The smartphone 142 acquires a first user response corresponding to a confirmation and a second user response corresponding to a duration of 2 hours. The smartphone 142 forwards both pieces of information to the controller 124 via the communication interface 126.

The controller 124 then controls the control element 118, the electric motor 116 and, if necessary, other relevant components of the kitchen appliance system 102 in such a way that a preparation process of the “sous-vide” type is carried out for a duration of 2 hours at a set temperature specified in the “sous-vide” quick start mode.

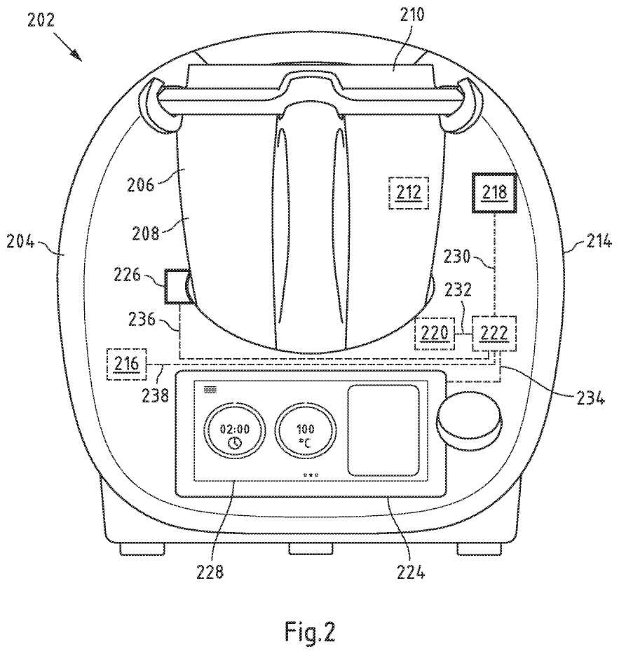

FIG. 2 shows another embodiment of a kitchen appliance system 202 with a base unit 204 and with an accessory 206.

The accessory 206 is a boiling vessel 208 configured for the “boiling water” function and having a lid 210, and has a data carrier 212 in the form of a barcode corresponding to a serial number of the accessory 206.

Similar to FIG. 1, the basic device 204 comprises a housing 214, a control element 216 for a heating element of the accessory 206, a detector 218, a storage medium 220 for a database, a controller 222 and a communication interface 224. In contrast to the embodiment example from FIG. 1, the detector 218 is designed as an optical reader for detecting machine-readable information from barcodes. Furthermore, a position sensing device 226 is additionally provided on the base unit 204 to cooperate with an element (not shown) arranged at the accessory 206 to detect an assembly or removal of the accessory 206 on the base unit 204. The communication interface 224 is a touch-sensitive screen 228.

The controller 222 is connected to the sensing device 218, to the storage medium 220, to the communication interface 224, to the position sensing device 226 and to the control element 216 respectively via a bidirectional communication link 230, 232, 234, 236, 238.

The kitchen appliance system 202, in particular the controller 222 is configured to perform the following method.

The position detector 226 detects an assembly of an accessory 206 and outputs a corresponding signal to the controller 222. After evaluation of this signal and corresponding detection of the assembly, the controller 222 causes the detector 218 to perform a detection process for identifying the assembled accessory 206. In this case, the detector 218 detects the serial number from the data carrier 212 of the accessory 206 and forwards corresponding information to the controller 222.

By comparing the captured serial number with serial numbers stored in the database, the controller 222 identifies the assembled accessory 206 as a cooking vessel 208 suitable for the “water boiling” function. Further, a “water boiling” operation mode is associated with the serial number of the accessory 206 in the database. Based on the detection of an assembly of this accessory 206, the controller 222 sets the set temperature for the control element 216 of the kitchen appliance system 202 to 100° C., which has not yet been set in the operation mode.

Subsequently, the controller 222 commands the communication interface 224 to individually display the operation mode thus changed. The “boiling water” operating mode is made available as a quick start mode by the automatic setting of the set temperature and the individual display. Simultaneously with the command to the communication interface 224, the controller 222 controls the control element 216 in such a way that a preparation process with a set temperature of 100° C. is started.

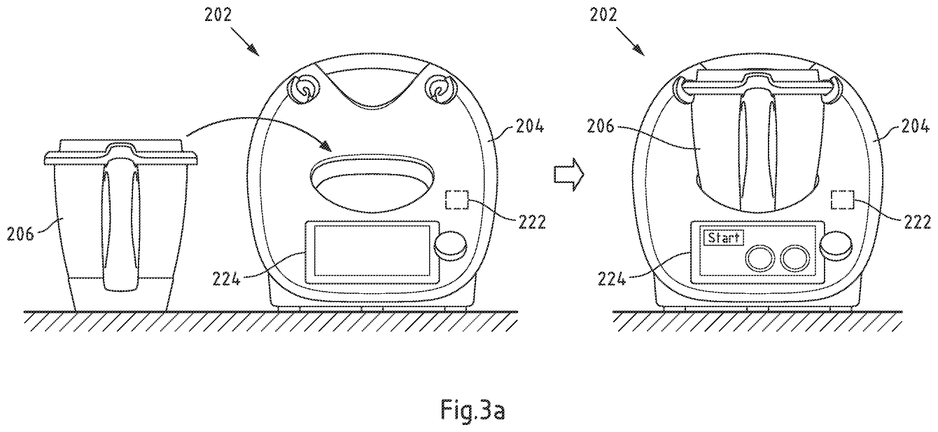

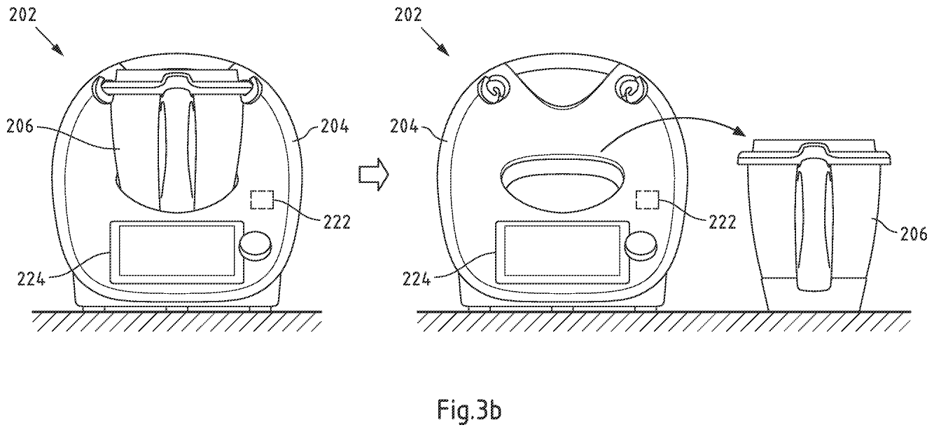

FIGS. 3a and 3b show a further embodiment of a kitchen appliance system 202, which is similar to the embodiment shown in FIG. 2. The same reference signs are used for the explanation of FIGS. 3a and 3b as in FIG. 2.

In the left part of FIG. 3a, the accessory 206 has been removed from the base unit 204 and the communication interface 224 is in an idle state and does not display an image. In the right part of FIG. 3a, the accessory 206 has been assembled with the base unit 204. The controller 222 has detected the assembly and identified the accessory 206. Accordingly, the controller 222 has activated the communication interface 224 and controlled it to display the quick start mode “boiling water” when it becomes active.

FIG. 3b shows the case where a quick start mode is already provided and accessory 206 is removed from base unit 204. Thus, in the left part of FIG. 3b, the accessory 206 is assembled with the base unit 204 and the communication interface 224 indicates the quick start mode “Boiling water”. After removal of the accessory 206, the kitchen appliance system 202 is in a state corresponding to the right part of FIG. 3b: as a result of detecting the removal, the controller 222 has stopped performing a “boiling water” preparation operation and the communication interface 224 has changed to a sleep mode.

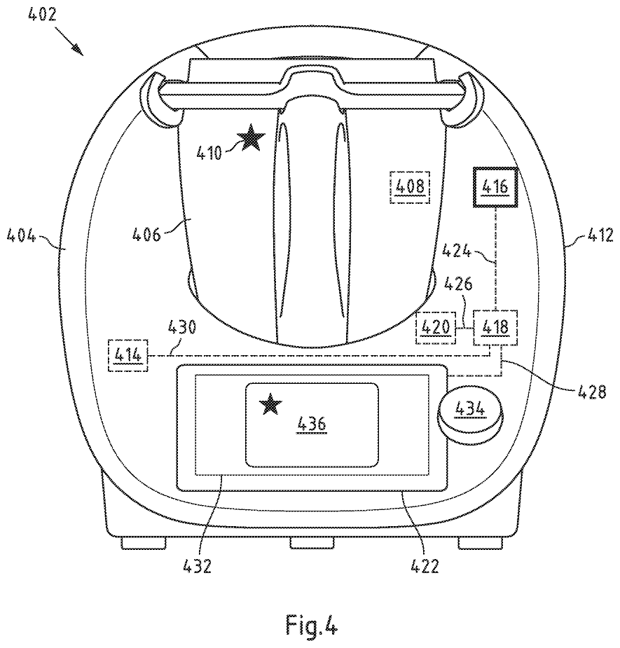

FIG. 4 shows another embodiment of a kitchen appliance system 402 with a base unit 404 and with an accessory 406.

The accessory 406 is designed as a cooking vessel that can be used for a wide variety of preparation processes. The accessory 406 has a data carrier 408 with an identifier stored as machine-readable information, which in this case is an identification number assigned uniquely and only for this specific accessory 406. The accessory 406 further has a visible unique feature 410 to facilitate recognition by the user, shown here as a star.

The base unit 404 comprises a housing 412, an electric motor 414, a detector 416, a controller 418, a storage medium 420 for a database and a communication interface 422. The controller 418 is connected to the acquisition device 416, to the storage medium 420, to the communication interface 422 and to the electric motor 414 via a communication link 424, 426, 428, 430 respectively. The communication interface 422 is designed as a screen 432 and as a multifunction button 434.

The kitchen appliance system 402 is configured to perform the following process.

When using this accessory 406 in connection with the base unit 404 for the first time, the controller 418 has, in accordance with a user input, linked a specific operation mode as a quick start mode in the database with the specific identifier of this specific accessory 406 and has additionally stored this quick start mode as a favourite.

In the case shown here, the accessory 406 is assembled a further time at the base unit 404. The controller 418 automatically compares the unique identification number captured by the capture device 416 with identification numbers from the database. Based on the earlier storage of the quick start mode as a “favourite” and the association with the identification number of the accessory 406 in the database, the controller 418 automatically provides this quick start mode 436 by displaying it on the communication interface 422. In doing so, the communication interface 422 displays an indication that it is a quick start mode 436 stored as a “favourite”.

At the same time, the controller 418 causes a preparation process to start according to the quick start mode by controlling the relevant functional parts of the kitchen appliance system 402 accordingly.

1. A kitchen appliance system,
wherein the kitchen appliance system comprises a base unit having a housing, a controller and a communication interface, and at least one accessory having an identifier,
wherein a detector configured to detect an identifier of at least one accessory is provided, and
wherein the controller is configured to
compare an identifier detected by the detection means with at least one identifier from a database, and
provide at least one operation mode associated with an identifier from the database matching the detected identifier via the communication interface as a quick start mode.

2. The kitchen appliance system according to claim 1,
wherein the quick start mode comprises at least one item from the list: a pre-set adapted to the accessory, a preparation instruction corresponding to a preparation operation which can be carried out with the accessory, a setpoint for a preparation parameter, a user request for a parameter setting, and a user request for a confirmation to start a preparation operation.

3. The kitchen appliance system according to claim 1,
wherein the controller is configured to
in response to detecting an identifier, switch the communication interface from an idle mode to an active mode; and
provide a quick start mode corresponding to the detected identifier via the communication interface when switching to active mode.

4. The kitchen appliance system according to claim 1,
wherein a position detector is provided and is configured to detect an assembly or removal of at least one accessory with respect to the base unit and/or with respect to a further accessory and to forward this to the controller, and
wherein the controller is configured to
provide a quick start mode in dependence of a detected identifier and of a detected assembly of an accessory,
and/or
terminate the provision of a quick start mode in dependence on a detected identifier and of a detected removal of an accessory.

5. The kitchen appliance system according to claim 1,
wherein the controller assigns a high priority rank, preferably the highest priority rank, to the quick start mode for being made available, and
wherein the controller provides information via the communication interface according to a prioritised arrangement.

6. The kitchen appliance system according to claim 5,
wherein the controller provides information via the communication interface in an order of descending priority rank.

7. The kitchen appliance system according to claim 1,
wherein the quick start mode has at least one user request, and
wherein the controller is configured to control functional parts of the kitchen appliance system according to indications from the quick start mode in dependence on a detected user response to the user request.

8. The kitchen appliance system according to claim 1,
wherein the quick start mode has at least one indication of a preparation process, and
wherein the controller is configured to start the execution of the preparation process simultaneously with the provision of the quick start mode and to control functional parts of the kitchen appliance system in dependence on the indications.

9. The kitchen appliance system according to claim 1,
wherein the controller is configured to
compare multiple detected identifiers with identifiers from a database, and
provide, as quick start modes, modes of operation which are each associated with all identifiers from the database matching a detected identifier.

10. The kitchen appliance system according to claim 1,
wherein the controller is configured to
save a quick start mode already provided in the past as a favourite, and
make the quick start mode saved as a favourite available separately when the same identifier is detected again.

11. A method of operating a kitchen appliance system according to claim 1,
wherein at least one identifier of an accessory is detected,
wherein the at least one detected identifier is compared with at least one identifier from a database, and
wherein at least one operation mode associated with an identifier matching the detected identifier is provided as a quick start mode.

12. The method according to claim 11,
wherein a communication interface is switched from an idle mode to an active mode as a result of detecting an identifier; and
wherein a quick start mode corresponding to the detected identifier is provided via the communication interface when switching to active mode.

13. The method according to claim 11,
wherein an assembly or removal of at least one accessory is detected with respect to the base unit and/or with respect to another accessory,
wherein a quick start mode is provided in dependence on a detected identifier and a detected assembly of an accessory,
and/or
wherein the provision of a quick start mode is terminated in dependence on a detected identifier and on a detected removal of an accessory.

14. The method according to claim 11,
wherein a high priority rank, preferably the highest priority rank, is assigned to the quick-start mode for making available, and
where quick start modes and/or other operation modes are made available in order of descending priority rank.

15. The method according to claim 11,
wherein a user response to a user request from a quick start mode is detected and functional parts of the kitchen appliance system are controlled in accordance with the quick start mode in dependence on the detected user response,
or
wherein, simultaneously with the provision of the quick start mode, execution of a preparation operation is automatically started in accordance with the quick start mode and functional parts of the kitchen appliance system are controlled in dependence on indications from the quick start mode.

16. The method according to claim 12,
wherein the provided quick start mode is saved as a favourite, and
wherein the quick start mode stored as a favourite is made available separately in the event of a subsequent, renewed detection of the same identifier.

17. A computer program comprising instructions, the execution of which on at least one processor of a controller of a kitchen appliance system causes a method according to claim 11 to be carried out.
